(19) United States
(12) Patent Application Publication
(10) Pub. No.: US 2006/0253659 A1
(43) Pub. Date: Nov. 9, 2006

(54) Method and virtual port register array for implementing shared access to a register array port by multiple sources

(75) Inventors: Todd Alan Greenfield, Rochester, MN (US); Philip Rogers Hillier III, Rochester, MN (US); Gene Leung, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: International Business Machines Corporation, Armonk, NY (US)

(21) Appl. No.: 11/122,806

(22) Filed: May 5, 2005

(51) Int. Cl. G06F 13/28

(52) U.S. Cl. 711/149

(57) ABSTRACT

A method and a virtual port register array are provided for implementing shared access to a register array port by multiple sources simultaneously. A plurality of write data stages is provided for transferring write data to a plurality of register arrays from the multiple sources. A plurality of read data stages is provided for transferring read data from the plurality of register arrays to the multiple sources. A respective multiplexer stage is coupled between the write data stages and the physical write port and the read data stages and the physical read port and clocking is provided to alternate register array access and to allow pass-through of only one source request at a time per physical write port and physical read port.

### FIELD OF THE INVENTION

The present invention relates generally to the data processing field, and more particularly, relates to a method and a virtual port register array for implementing shared access to a register array port by multiple sources simultaneously.

### DESCRIPTION OF THE RELATED ART

For designs that require the use of a register array, the fixed number of physical ports of the register array can become a bottleneck for accesses that originate from multiple sources.

For example, an array with two read and two write (2R/2W) ports is only able to support two sources without modification.

A need exists for an effective mechanism for implementing shared access to a register array port by multiple sources simultaneously. It is desirable that such mechanism would allow for fixed timings without requiring that requests be queued. It is desirable that such mechanism would not introduce unnecessary redundancy. Further it is desirable that such mechanism would not have a substantial adverse effect on either chip area or performance.

### SUMMARY OF THE INVENTION

Principal aspects of the present invention are to provide a method and a virtual port register array for implementing shared access to a register array port by multiple sources simultaneously. Other important aspects of the present invention are to provide such method for implementing shared access to a register array port by multiple sources simultaneously and virtual port register array substantially without negative effect and that overcome many of the disadvantages of prior art arrangements.

In brief, a method and a virtual port register array are provided for implementing shared access to a register array port by multiple sources simultaneously. A virtual port register array includes a plurality of register arrays, each including at least one physical write port and at least one physical read port. A plurality of write data stages is provided for transferring write data to the plurality of register arrays from the multiple sources. A plurality of read data stages is provided for transferring read data from the plurality of register arrays to the multiple sources. A first multiplexer stage is coupled between the write data stages and the physical write port and a second multiplexer stage is coupled between the read data stages and the physical read port and clocking is provided to alternate register array access and to allow pass-through of only one source request per physical write port and physical read port.

In accordance with features of the invention, a plurality of address and write enable stages couple address and write enable signals to the plurality of register arrays from the multiple sources. The address and write enable stages are clocked at a first clock frequency and the write data stages are clocked at a second clock frequency. A plurality of read address stages couple read address signals to the plurality of register arrays. The read address stages are clocked at the first clock frequency and the read data stages are clocked at the second clock frequency.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic diagram illustrating an exemplary virtual port register array including an exemplary virtual port write logic interface in accordance with the preferred embodiment;

FIGS. 2 and 3 together provide a timing diagram illustrating operation of the exemplary virtual port register array including the exemplary virtual port write logic interface with two sources writing a cache line using the same register array port in accordance with the preferred embodiment;

FIG. 4 is a schematic diagram illustrating an exemplary virtual port register array including an exemplary virtual port read logic interface in accordance with the preferred embodiment; and

FIG. 5 are timing diagrams illustrating operation of the exemplary virtual port register array including the exemplary virtual port read logic interface with two sources reading a cache line using the same register array port in accordance with the preferred embodiment.

### DETAILED DESCRIPTION OF THE PREFERRED EMBODIMENTS

In accordance with features of the invention, a method and virtual port logic interface are provided that effectively allows more sources than physical ports to simultaneously access a storage array. A virtual port data buffer uses a combination of clocking techniques to alternate buffer access and a layer of logic to allow pass-through of only one source request per physical port at a time. A similar method is used on the array output to pipe the appropriate data to the read request source.

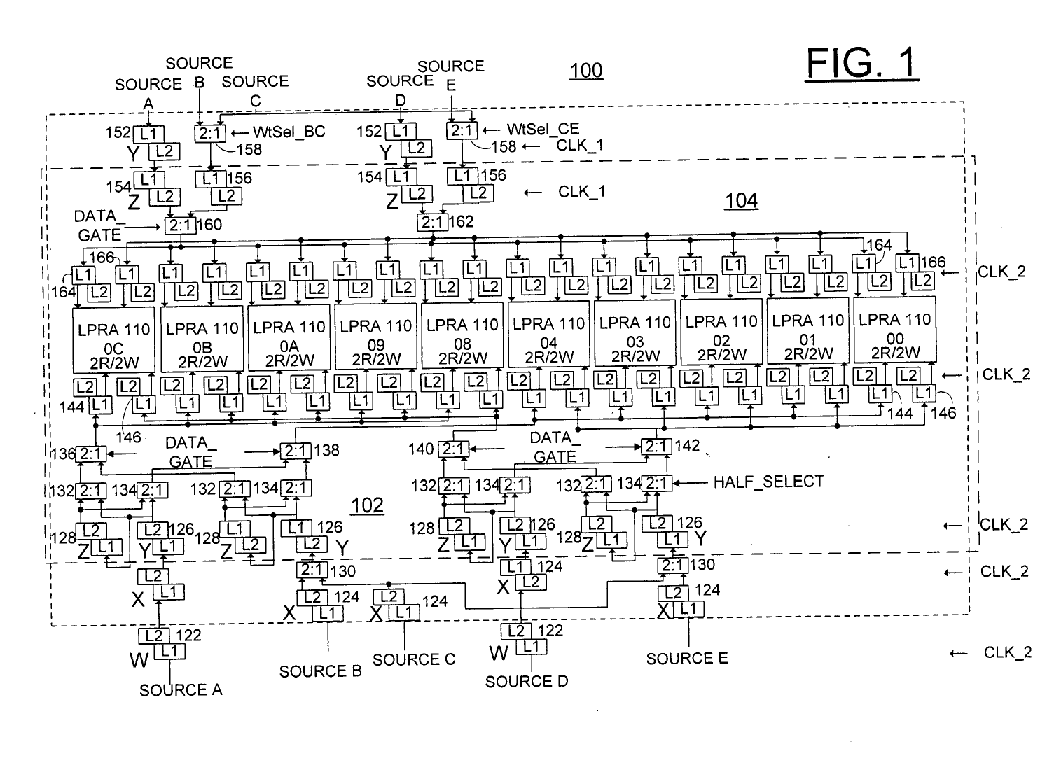

Having reference now to the drawings, in FIG. 1, there is shown an exemplary virtual port register array generally designated by the reference character 100 including an exemplary virtual port write logic interface generally designated by the reference character 102 in accordance with the preferred embodiment. Virtual port register array 100 includes a virtual port address and write enable logic interface generally designated by the reference character 104.

Virtual port register array 100 includes a plurality of register arrays 110, each implemented for example, by a latch port register array (LPRA). Each of the plurality of register arrays 110 has 2 read and 2 write ports (2R/2W) ports. As shown, virtual port register array 100 supports a plurality of sources A-E.

In accordance with features of the invention, virtual port register array 100 introduces minimal latency and the increase to cell count is negligible. For implementations that require two times the number of physical ports or less, it appears to each source that the source has its own port to the array; and read and write latencies are pre-determined and predictable. If more virtual ports are required, low bandwidth sources can be multiplexed to take advantage of gaps in dataflow. The number of physical ports is much less of a limiting factor as virtual ports can be added with greater flexibility and the cost requirement of developing and supporting a custom array is avoided.

In the illustrated configuration of the virtual port register array 100 includes a 5-to-2 write port mapping. Source C shares an interface to the data buffer with Sources B and D and is able to perform a write when those interfaces have gaps in dataflow. In effect, Sources A, B and C share physical port 1, while Sources C, D and E share physical port 2.

Virtual port write logic interface 102 includes a plurality of register stages W, X, Y, Z respectively defined by a plurality of shift register latches 122, 124, 126, 128 coupled to respective sources A-E, as shown. Each of the shift register latches (SRLs) 122, 124, 126, 128 includes the two internal latches L1 latch, L2 latch, as shown.

It should be understood that the present invention is not limited to the use of shift register latches (SRLs) to implement the register stages W, X, Y, Z, for example, other latches or flip-flops could be used.

Source A and Source D are connected to the respective first stage W, SRL 122. Sources B, C and E and output of the first stage W, SRL 122 are connected to respective second stage X, SRL 124. In the data path of Source A and Source D, the output of the second stage W, SRL 124 is connected to the respective third stage Y, SRL 126. In the path of Source B, Source C and Source E, Source C, the output of the second stage W, SRL 124 is connected by a respective two-to-one multiplexer (2:1) 130 to the respective third stage Y, SRL 126. The output of each respective third stage Y, SRL 126 is applied to a respective fourth stage Z, SRL 128 and to a respective input of each of a respective pair of two-to-one multiplexers (2:1) 132, 134.

A half_select signal is applied to a select input of each of the two-to-one multiplexers (2:1) 132, 134. In the data paths of Source A and Sources B and C, the output of each multiplexers (2:1) 132 is applied to a respective input of a two-to-one multiplexer (2:1) 136. In the data path of Source A and Sources B and C, the output of each multiplexers (2:1) 134 is applied to a respective input of a two-to-one multiplexer (2:1) 138. In the data paths of Source E and Sources C and D, the output of each multiplexers (2:1) 132 is applied to a respective input of a two-to-one multiplexer (2:1) 140. In the data path of Source E and Sources C and D, the output of each multiplexers (2:1) 134 is applied to a respective input of a two-to-one multiplexer (2:1) 142.

A data_gate signal is applied to a select input of each of the two-to-one multiplexers (2:1) 136, 138, 140, 142. In the data paths of Source A and Sources B and C, the output of each multiplexers (2:1) 136, 138 respectively is applied to a respective SRL 144 coupled to a first write port of a respective group of five register arrays 110. In the data path of Source E and Sources C and D, the output of each multiplexers (2:1) 140, 142 respectively is applied to a respective SRL 146 coupled to a second write port of a respective group of five register arrays 110.

Virtual port address and write enable logic interface 104 includes a pair of register stages Y, Z respectively defined by a plurality of shift register latches (SRLs) 152, 154, 156 coupled to respective sources A-E, as shown.

Source A and Source D are connected to the respective stage Y, SRL 152. Sources B and C and Sources E and C are respectively coupled by a respective two-to-one multiplexer (2:1) 158 to the respective stage Z, SRL 156.

A WtSel_BC signal is applied to the multiplexer (2:1) 158, which is coupled to Source B and Source C. A WtSel_CE signal is applied to the multiplexer (2:1) 158, which is coupled to Source C and Source E.

In the address and write enable path of source A and Sources B and C, the output of each respective stage Z, SRL 154, 156 is applied to a respective input of a two-to-one multiplexer (2:1) 160. In the address and write enable path of source E and Sources C and D, the output of each respective stage Z, SRL 154, 156 is applied to a respective input of a two-to-one multiplexer (2:1) 162. A DATA_GATE select signal is applied to each of the multiplexers (2:1) 160, 162.

In the address and write enable path of source A and Sources B and C, the output of each multiplexer (2:1) 160 is applied to a respective SRL 164, each having an output coupled to a port 1 or first address and write enable input of each of the register arrays 110. In the address and write enable path of source E and Sources C and D, the output of multiplexer (2:1) 162 is applied to a respective SRL 166, each having an output coupled to a port 2 or second address and write enable input of each of the register arrays 110.

Virtual port register array 100 includes a first clock CLK 1, and a second clock CLK 2. Clock CLK 1 operates at half the frequency of clock CLK 2, the clock CLK 2 is the speed at which the register arrays 110 accept data. The DATA_GATE signal alternates address and write enable access to the register arrays 110 and toggles at a rate of CLK 1. To pipe the write data, half of the total data is sent from a particular source and latched into the data buffer or register arrays 110 at twice the frequency of the address logic interface 104. Depending on the write address (HALF_SELECT), the critical half of data is directed to and gated into the appropriate register arrays 110.

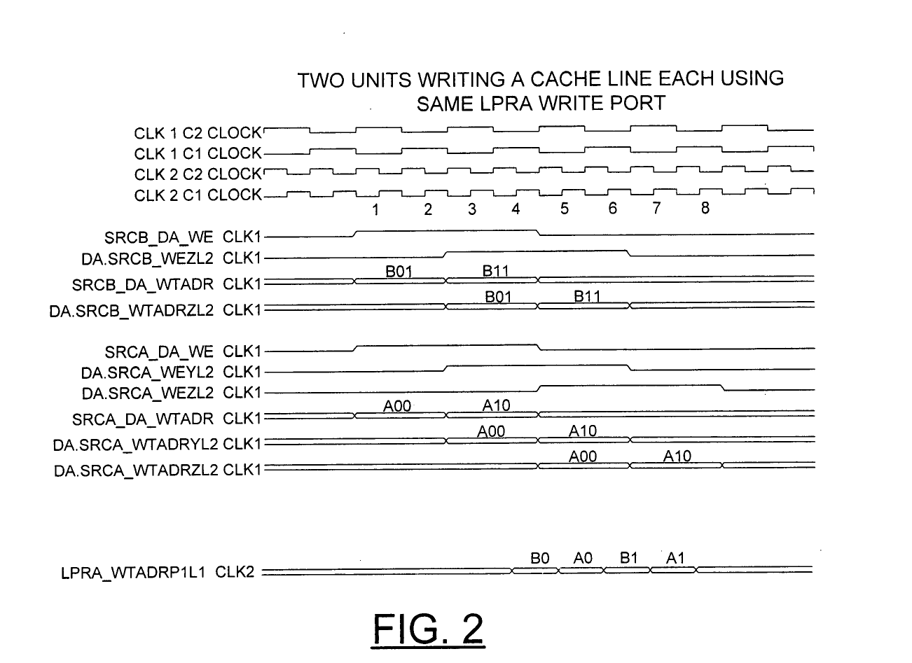

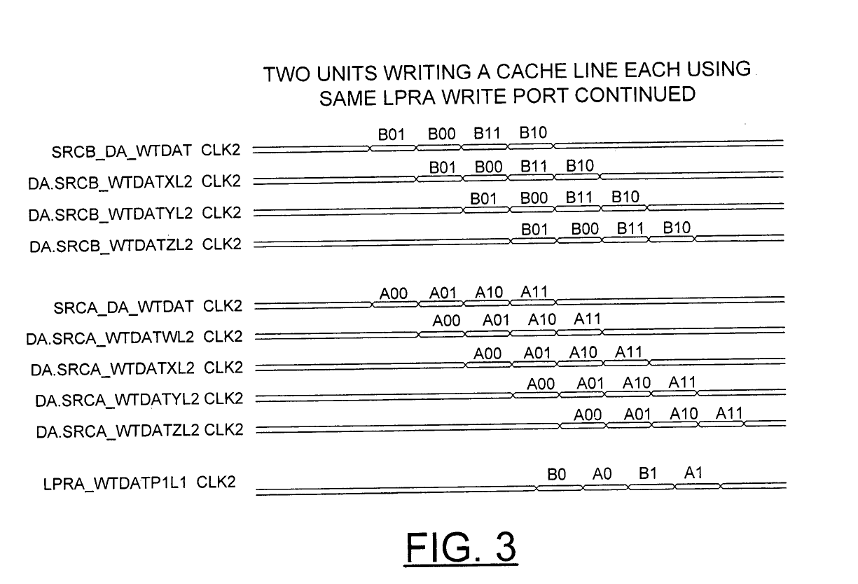

Referring also to FIGS. 2 and 3, there is shown a timing diagram illustrating operation of the exemplary virtual port register array 100 including the virtual port write logic interface 102 and virtual port address and write enable logic interface 104 with two sources A, B writing a cache line using the same register array port in accordance with the preferred embodiment. As shown, the timing diagram depicts simultaneous writes from the two sources A, B sharing the same physical port assuming the write data is transferred in quarter-cache line blocks.

In FIG. 2, at the top of the diagram there are shown clock signals CLK 1 C2 CLOCK, CLK 1 C1 CLOCK, CLK 2 C2 CLOCK, CLK 2 C1 CLOCK. Next there are shown Source B write enable and address CLK1 signals SRCB_DA WE CLK1, DA.SRCB_WEZL2 (stage Z, L2 of SRL 154); SRCB_DA_WTADR CLK1, and DA.SRCB_WTADRZL2 (stage Z, L2 of SRL 154). Next there are shown Source A write enable and address CLK1 signals SRCA_DA WE CLK1, DA.SRCA_WEYL2 (stage Y, L2 of SRL 152); DA.SRCA_WEZL2 (stage Z, L2 of SRL 154); SRCA_DA_DA_WTADR CLK1, DA.SRCA_WTADRYL2 (stage Y, L2 of SRL 152); and DA.SRCA_WTADRZL2 (stage Z, L2 of SRL 154). At the bottom of the diagram there is shown the write enable and address CLK2 signal LPRA_WTADRP1L1 CLK2 (SRL 164 having an output coupled to the port 1 or first address and write enable of each of the register arrays 110).

In FIG. 3, at the top of the diagram there are shown Source B write data CLK2 signals SRCB_DA_WTDAT CLK2; SRCB_DA_WTDATXL2 CLK2 (stage X, L2 of SRL 124); SRCB_DA_WTDATYL2 CLK2 (stage Y, L2 of SRL 126); and SRCB_DA_WTDATZL2 CLK2 (stage Z, L2 of SRL 128). Next there are shown Source A write data CLK2 signals SRCA_DA_WTDAT CLK2; SRCA_DA_WTDATXL2 CLK2 (stage W, L2 of SRL 122); SRCA_DA_WTDATXL2 CLK2 (stage X, L2 of SRL 124); SRCA_DA_WTDATYL2 CLK2 (stage Y, L2 of SRL 126); and SRCA_DA_WTDATZL2 CLK2 (stage Z, L2 of SRL 128). At the bottom of the diagram there is shown the write CLK2 signal LPRA_WTDATP1L1 CLK2 (SRL 144 having an output coupled to the write port 1 each of the register arrays 110).

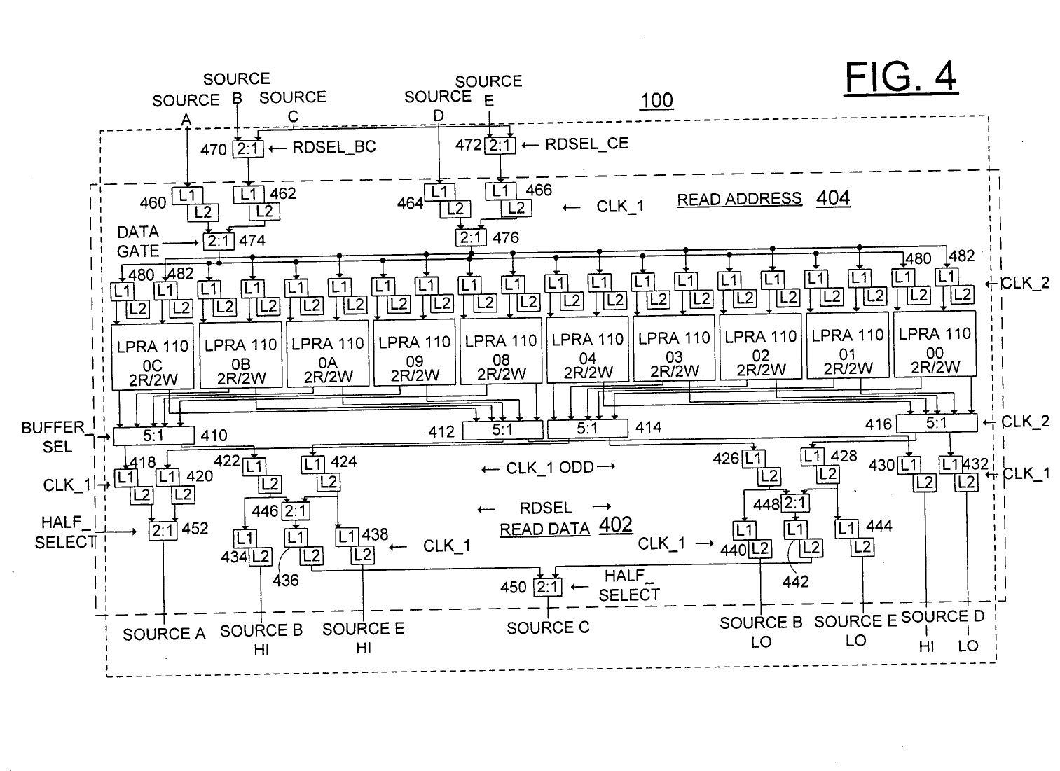

Referring now to FIG. 4, there is shown the exemplary virtual port register array 100 including an exemplary virtual port read logic interface 402 and an exemplary virtual port read address interface 404 in accordance with the preferred embodiment.

Virtual port read logic interface 402 includes a plurality of five-to-one multiplexers (5:1) 410, 412, 414, 416. A BUFFER_SEL signal is applied to each of the multiplexers (5:1) 410,412, 414, 416. A respective pair of SRLs 418, 420; 422, 424; 426, 428; and 430, 432, are connected to the output of respective multiplexers (5:1) 410, 412, 414, 416, as shown.

In the illustrated 5-to-2 read port configuration of FIG. 4, Sources A, B, and C share physical read port 1, and Sources C, D, and E share physical read port 2. A plurality of SRLs 434, 436, 438, 440, 442, 444 are coupled to respective SRLs 422, 424, 426, 428, which are clocked at a frequency of CLK1 Odd. A pair of two-to-one multiplexers (2:1) 446, 448 is coupled between the respective pairs of SRLs 422, 424 and SRLs 426, 428 and the respective SRL 436, 442. A two-to-one multiplexers (2:1) 450 having a HALF_SELECT input is coupled between the SRL 436, 442 and Source C. A two-to-one multiplexers (2:1) 452 having the HALF_SELECT input is coupled between the SRL 418, 420 and Source A.

Virtual port read address interface 404 includes a plurality of SRLs 460, 462, 464, 466 with Source A and Source D coupled to the respective SRL 460, 464. A pair of two-to-one multiplexers (2:1) 470, 472 coupled between Source B, Source C; and Source E, Source C and the respective SRL 462, 466. A RDSEL_BC is applied to multiplexer (2:1) 470 and a RDSEL_CE is applied to multiplexer (2:1) 474. A pair of two-to-one multiplexers (2:1) 474, 476 is coupled between a respective SRL 480, 482, each having an output coupled to a respective read address port of each of the register arrays 110.

The clock signal CLK 1 runs at half the frequency of CLK 2. Read data comes off the register arrays 110 at a rate of CLK2 and is latched at a frequency of either CLK 1 Odd or CLK 1, which is effectively CLK 2 combined. Data latched in the Odd domain are synchronized with an additional latch in the CLK 1 domain. The signal HALF_SELECT toggles at a rate of CLK 2, and routes the appropriate half of the read data. The upper and lower portions of read data exit the data buffer in parallel for Sources B, D and E.

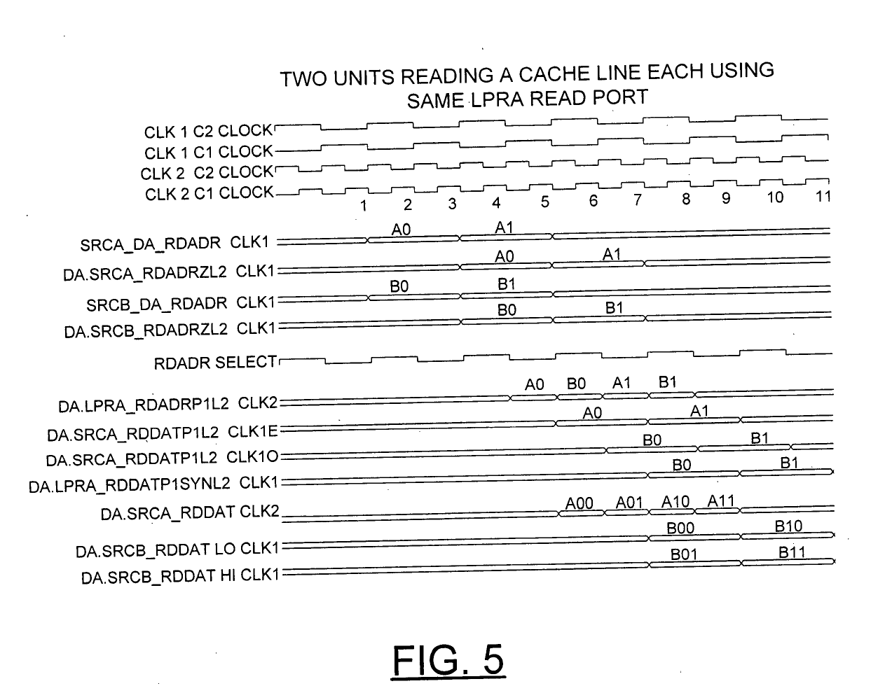

Referring also to FIG. 5, there is shown a timing diagram illustrating operation of the exemplary virtual port register array 100 including the exemplary virtual port read logic interface 402 with two sources A, B reading a cache line using the same register array port in accordance with the preferred embodiment.

In FIG. 5, at the top of the diagram there are shown clock signals CLK 1 C2 CLOCK, CLK 1 C1 CLOCK, CLK 2 C2 CLOCK, CLK 2 C1 CLOCK. Next there are shown Source A read address CLK1 signals SRCA_DA RDADR CLK1; and DA.SRCA_RDADRZL2 CLK1 (stage Z, L2 of SRL 460). Next there are shown Source B read address CLK1 signals SRCB_DA RDADR CLK1; and DA.SRCB_RDADRZL2 CLK1 (stage Z, L2 of SRL 462). Next there is shown a read address select signal RDADR SELECT.

Next below the read address select signal RDADR SELECT, there are shown the Source A read address and read data signals DA.LPRA_RDADRP1L1 CLK2 (SRL 480 having an input coupled to the read address port 1 of each of the register arrays 110); DA.SRCA_RDDATP1L1 CLK1E (CLK 1 even); and DA.SRCA_RDDATP1L1 CLK1O, (CLK 1 odd); and DA.LPRA_RDDATP1SYNL1 CLK1 (Synchronize CLK 1).

At the bottom of the diagram in FIG. 5, there are shown the read data CLK2, low and high CLK1 signals DA.SRCA_RDDAT CLK2 (multiplexers 410, 412 having an input coupled to the read port 1 of each of the register arrays 110); DA.SRCB_RDDAT LO CLK1 and DA.SRCB_RDDAT HI CLK1.

While the present invention has been described with reference to the details of the embodiments of the invention shown in the drawing, these details are not intended to limit the scope of the invention as claimed in the appended claims.

What is claimed is:

1. A virtual port register array for implementing shared access to a register array port by multiple sources simultaneously, said virtual port register array comprising:
a plurality of register arrays, each including at least one physical write port and at least one physical read port;
a plurality of write data stages for transferring write data to the plurality of register arrays from the multiple sources;
a plurality of read data stages for transferring read data from the plurality of register arrays to the multiple sources;
a first multiplexer stage coupled between said write data stages and said physical write port to allow pass-through of only one source request at a time to said physical write port;
a second multiplexer stage coupled between said read data stages and said physical read port to allow pass-through of only one source request at a time to said physical read port; and
said write data stages, said read data stages and said first and second multiplexer stages being clocked for alternating register array access by the multiple sources.

2. A virtual port register array as recited in claim 1 includes a plurality of address and write enable stages for coupling address and write enable signals to the plurality of register arrays from the multiple sources.

3. A virtual port register array as recited in claim 2 wherein the address and write enable stages are clocked at a first clock frequency and the write data stages are clocked at a second clock frequency.

4. A virtual port register array as recited in claim 3 wherein said second clock frequency is higher than said first clock frequency.

5. A virtual port register array as recited in claim 1 includes a plurality of read address stages for coupling read address signals to the plurality of register arrays.

6. A virtual port register array as recited in claim 5 wherein said read address stages are clocked at the first clock frequency and the read data stages are clocked at the second clock frequency.

7. A virtual port register array as recited in claim 7 wherein said second clock frequency is higher than said first clock frequency.

8. A virtual port register array as recited in claim 1 wherein each of said plurality of register arrays includes two physical read ports and two physical write ports and wherein a pair of sources is coupled to each of said two physical read ports and said two physical write ports.

9. A virtual port register array as recited in claim 8 includes a low bandwidth source having a multiplexed data path with one source of each said pair of sources.

10. A virtual port register array as recited in claim 9 wherein said plurality of register arrays includes ten register arrays and wherein said first multiplexer stage includes a pair of two-to-one multiplexers coupled to each of said two physical write ports.

11. A virtual port register array as recited in claim 9 wherein said plurality of register arrays includes ten register arrays and wherein said second multiplexer stage includes a pair of five-to-one multiplexers coupled to each of said two physical read ports.

12. A virtual port register array as recited in claim 1 wherein said first multiplexer stage is coupled to the physical write port by a latch.

13. A virtual port register array as recited in claim 1 wherein said plurality of write data stages for transferring write data to the plurality of register arrays from the multiple sources include a plurality of shift register latches.

14. A virtual port register array as recited in claim 1 wherein said plurality of read data stages for transferring read data from the plurality of register arrays from the multiple sources include a plurality of shift register latches.

15. A method for implementing shared access to a register array port by multiple sources coupled to a plurality of register arrays, each register array including at least one physical write port and at least one physical read port; said method comprising the steps of:
providing a plurality of write data stages, each of said plurality of write data stages for transferring write data to the plurality of register arrays from a respective source of the multiple sources;
providing a plurality of read data stages, each of said plurality of read data stages for transferring read data from the plurality of register arrays to a respective source of the multiple sources;
selecting between said write data stages to allow pass-through of only one source request at a time to said physical write port;
selecting between said read data stages to allow pass-through of only one source request at a time to said physical read port; and
clocking said plurality of write data stages and said plurality of read data stages for alternating register array access between the multiple sources.

16. A method for implementing shared access to a register array port by multiple sources as recited in claim 15 includes the steps of multiplexing a low bandwidth source with another source of the multiple sources and providing control signal for selecting between multiplexed sources.

17. A method for implementing shared access to a register array port by multiple sources as recited in claim 15 includes the steps of providing a plurality of write address and write enable stages for coupling write address and write enable signals to the plurality of register arrays from the multiple sources; clocking said write address and write enable stages at a first clock frequency; and clocking the write data stages at a second clock frequency, said second clock frequency being higher than said first clock frequency.

18. A method for implementing shared access to a register array port by multiple sources as recited in claim 15 includes the steps of providing a plurality of read address stages for coupling read address signals to the plurality of register arrays; clocking said read address stages at a first clock frequency; and clocking the write data stages at a second clock frequency; said second clock frequency being higher than said first clock frequency.
